(19) United States
(12) Patent Application Publication
(10) Pub. No.: US 2011/0192789 A1
(43) Pub. Date: Aug. 11, 2011

(54) METAL OR METAL OXIDE DEPOSITED FIBROUS MATERIALS

(75) Inventors: Yury Gogotsi, Ivyland, PA (US); Byung-Yong Lee, Jenkintown, PA (US); Kris Behler, Elkton, MD (US); Richard Rest, Bryn Mawr, PA (US)

(73) Assignee: DREXEL UNIVERSITY, PHILADELPHIA, PA (US)

(21) Appl. No.: 13/060,801

(22) PCT Filed: Sep. 2, 2009
(86) PCT No.: PCT/US09/55696

§ 371 Date: Feb. 25, 2011

Related U.S. Application Data
(60) Provisional application No. 61/190,785, filed on Sep. 2, 2008.

(51) Int. Cl. B01D 39/14; B05B 5/025; B05D 1/36; B01D 39/16; B01D 39/20

(52) U.S. Cl. 210/504; 427/483; 427/470; 210/505

(57) ABSTRACT

A method for electrospraying nanosized metal or metal oxide particles onto a substrate. A metal oxide deposited fibrous material comprising a substrate, fibers and metal oxide particles may be made using the method. The material may be a flexible and porous fibrous matrix on which metal oxide particles may be uniformly deposited on a surface thereof. In an exemplary embodiment, the invention is directed to an electrospun nanofibrous material on which electrosprayed photocatalytic metal oxide particles are uniformly deposited without agglomeration.

### BACKGROUND OF THE INVENTION

1. Field of Invention

The present invention is directed to deposition of metals or metal oxides on fibrous materials and to the products and application thereof.

2. Brief Description of the Prior Art

An increase in bioterrorism and microbial epidemics has driven the recent development of improved filtration systems. Among the various new technologies being investigated, electrospun fibers are particularly promising. It has been found that electro-spinning may be used to customize the physical and material properties of the synthesized fibers, including producing fibers having diameters ranging from several nanometers to several micrometers. This ability to select the characteristics of the electrospun fibers enables the production of filters suitable for fine filtration applications.

Electrospinning, also known as electrostatic spinning, has been known since the 1930s and is a technique in which an electric field causes the deposition of small fibers on a substrate or collection surface. A positive charge is applied to a melted polymer or a solution of dissolved polymer, and possible filler material in the case of composites, usually held in a syringe as shown in FIG. 1 (a) [Yury Gogotsi (editor), Nanomaterials Handbook, 2006]. The solution at low voltage does not have enough energy to overcome the surface energy at the capillary. When the supplied voltage is increased past a threshold, the dissolved polymer solution forms a Taylor cone and the applied electrostatic force overcomes the surface energy and the solution is ejected in a random spinning motion called a jet, sometimes compared to a spider spinning thread. When the solution is traveling from the cone, the solvent used to dissolve the polymer evaporates before collecting on the substrate leaving behind thin polymer fibers. If the given voltage is further increased, the Taylor cone becomes unstable and a spraying effect, electrospraying or electrostatic spraying, occurs in where many droplets of polymer are expelled but do not form long, continuous, nanofibers.

This is a useful process to produce the nanofibers from a polymer solution because it can effectively produce fibers with diameter ranging from several nanometers to several micrometers using various polymers. The morphologies and physical properties of the nanofibers generally depend on the polymer solution properties and the electrospinning process parameters such as polymer molecular weight, solvents, polymer concentration and applied electric fields strength and the tip-to-collector distance (TCD).

Using these versatile properties of the electrospinning processes, one can largely categorize and extend the potential applications of the electrospun fibers to biomedical (tissue, scaffolds, life science), electronic (electronic packaging, sensors, actuators, fuel cell) and filtration (filtration media, anti-bio/chemical-protection) systems. Among these potential application fields, filtration systems have become the focus because of the fear of bioterrorism and potential epidemics of viruses and influenza lead to increased demand of the development of much improved antibacterial and antivirus materials for filtration systems.

Current electrospun nanofibers, however, do not possess antimicrobial properties suitable for containing or rendering bacteria and/or viruses ineffective. Therefore, metal oxides having photocatalytic, antibacterial and antiviral properties could be applied to electrospun nanofiber networks. Conventional methods of providing metal oxide particles typically involve deposition of a titania precursor followed by a calcination step to convert the precursor to titania. The reason for this is that it is difficult to uniformly deposit of ultra fine titania without agglomeration of the titania to form larger particle. Also, in the case of many conventional filters, the mesh size is over 20 micrometer and thus is too large to trap microorganisms such as viruses and bacteria and most of microorganisms pass through the filter without contact with titania on the filter fibers. This makes the efficiency of photocatalytic antibacterial activity very low. Therefore, in order to increase of the bactericidal activity of titania coated fibers, nanometer sized titania particles should be uniformly deposited onto nanofibers which have smaller mesh size and larger surface area compared to the conventional filter fibers. The use of nanosized particles allows an increase in the number of particles per unit area, and thus the antimicrobial effect can be maximized.

Conventional methods involving deposition of titania precursors require a calcinations step to convert the precursor to titania. Such calcination steps may require temperatures as high as 400° C., which temperatures would destroy many types of polymeric fibers. For example, references such as Li, Dan et al. “Fabrication of Titania Nanofibers by Electrospinning” Nano Letters 2003 vol. 3, no. 4, pages 555-560 and Park, Soojin et al., “Morphology and crystalline phase study of electrospun TiO₂—SiO₂ nanofibers” Nanotechnology 2003 vol. 14, pages 532-537, disclose methods which involve synthesis of a polymer blend titania and titania-silica compound using a sol-gel process for deposition on electrospun nanofibers. These methods require a calcination step occurring at temperatures greater than 400° C. for at least 2 hours to form the titania particles. This calcination process consequently burns away almost all of the electrospun polymer as well as traditional polymer fiber filters, producing crystallized electrospun metal oxide particle films.

Although references, such as Bottcher, H. et al. “Fictionalization of textiles by inorganic sol-gel coatings” J. Mater. Chem. 2005 vol. 15, pages 4385-4395 and J. Kiwi et al. “Synthesis, activity and characterization of textiles showing self-cleaning activity under daylight irradiation” Catalysis Today 2007 vol. 122, pages 109-117, discuss the use of antimicrobial metal oxide additives, such as photocatalytic titania, in fabric applications, the deposition methods employed do not provide sufficiently effective results for antimicrobial applications. Conventional metal oxide particles deposited fibrous substrates have pore sizes exceeding 20 micrometers, which is too large to trap microorganisms such as viruses and bacteria. Therefore the large pores of these prior art materials are incapable of fine filtration. Also, since most microorganisms pass through the filter without contacting the metal oxide particles, these filters are inefficient and ineffective for antimicrobial applications.

U.S. Patent Publication No. 2008/0110342 (Ensor) discloses a method for synthesizing nanofiber mats for use in filtration that involves electrospinning nanofibers, such as polyamides. Applying a polymer coating over the components of the mesh may be used to modify the surface of the filter support mesh. For catalysis applications, the electrospun nanofiber mats may incorporate catalytic metal particles, such as nanoparticulate metals or metal oxides, either during or after electrospinning (See paragraphs 190-191 of Ensor). Ensor further suggests that photocatalytic metal oxide particles, such as titania, may be added for antimicrobial applications in accordance with the process described in Kenawy, E. R. and Y. R. Abdel-Fattah (2002) “Antimicrobial properties of modified and electrospun poly(vinyl phenol).” Macromolecular Biosciences 2(6): 261-266. (See paragraph 198 of Ensor). However, the methods of Ensor and Kenaway et al. do not achieve a sufficiently uniform distribution of metal oxide particles on the nanofiber mat to provide the desired level of antimicrobial activity. The method of Kenawy et al. involves dip coating a nanofiber material with a titania suspension. A significant disadvantage of dip coating is that the titania particles tend to form agglomerates which may block the pores of the nanofiber mesh and lead to an uneven distribution of the titania in the mesh.

Other references such as U.S. Patent Publication No. 2006/0094320 (Chen) and related U.S. Pat. No. 7,390,760 (Chen) disclose a composite nanofiber material, wherein photocatalytic metal oxide particles, such as titania, may be added as a dry powder or entrained in a mist or spray (See paragraph 75). However, in the methods of Chen, the titania particles are added during the fiber electrospinning step and thus many of the titania particles become embedded within the electrospun fiber rather than coated on the surface. As a result, significant antimicrobial activity is lost.

Therefore, there remains a need for improved methods for providing a more uniform deposition of nanometer sized metal or metal oxide particles on substrates such as fibers and textiles to impart antimicrobial properties. Previous attempts have failed to provide a suitably uniform deposition of fine particles without agglomeration to larger particles, thereby compromising the antimicrobial activity of the products.

### SUMMARY OF THE INVENTION

The invention is directed to a method for deposition of metals or metal oxides, products made by such methods and uses of the products.

In one embodiment, the invention is directed to a method for depositing a metal or metal oxide onto a substrate. In the method, metal or metal oxide particles are electrosprayed onto a substrate. The method of the present invention may be used, for example, in a process for making filtration devices, which process involves providing a substrate, electrospinning a polymer solution to form a fiber matrix on the substrate and electrospraying metal or metal oxide particles on the fiber matrix.

In another embodiment, the invention relates to products produced by the method of the present invention. The invention also relates to methods of using such products in various applications such as artificial tissues and scaffolds, electronic applications, such as electronic packaging, sensors, actuators and fuel cells, and filtration systems, such as filtration media and biological and chemical protection systems.

### BRIEF DESCRIPTION OF THE DRAWINGS

FIG. 1 is a schematic drawing of an unmodified filter substrate.

FIG. 2 is a schematic drawing of a filter substrate coated with a silica binder agent.

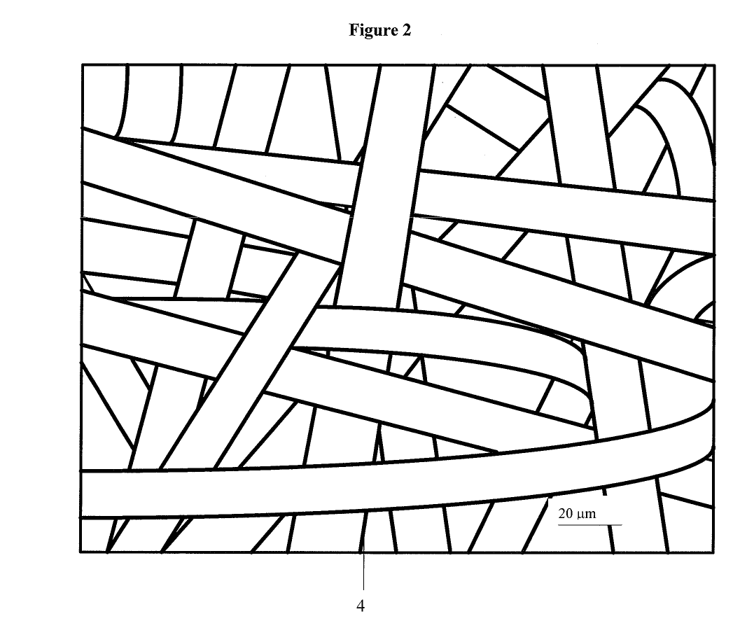

FIG. 3 is a schematic drawing of electrospun polyamide nanofibers on a filter substrate coated with a silica binder agent.

FIG. 4 is a diagram showing the electrospinning process.

FIG. 5 is a schematic drawing of electrosprayed titania deposited particles on an electrospun polyamide nanofiber on a filter substrate coated with a silica binder agent.

FIG. 6(a) is a SEM of electrospun nanofibers on a polypropylene filter deposited with substantially uniformly dispersed titania particles of about 10 microns.

FIG. 6(b) is a SEM of electrospun nanofibers on a polypropylene filter with agglomerated titania particles that were deposited using a prior art dipping method.

FIG. 7 is a diagram showing the antimicrobial filter application.

FIG. 8 shows x-ray diffraction patterns of titania deposited onto the electrospun nanofiber and the raw titania powder (P25, Degussa).

### DETAILED DESCRIPTION OF THE PREFERRED EMBODIMENTS

For illustrative purposes, the principles of the present invention are described by referencing various exemplary embodiments thereof. Although certain embodiments of the invention are specifically described herein, one of ordinary skill in the art will readily recognize that the same principles are equally applicable to, and can be employed in other apparatuses and methods. Before explaining the disclosed embodiments of the present invention in detail, it is to be understood that the invention is not limited in its application to the details of any particular embodiment shown. The terminology used herein is for the purpose of description and not of limitation. Further, although certain methods are described with reference to certain steps that are presented herein in certain order, in many instances, these steps may be performed in any order as may be appreciated by one skilled in the art, and the methods are not limited to the particular arrangement of steps disclosed herein.

It must be noted that as used herein and in the appended claims, the singular forms “a”, “an”, and “the” include plural references unless the context clearly dictates otherwise. Thus, for example, reference to “a metal oxide” may include a plurality of metal oxides and equivalents thereof known to those skilled in the art, and so forth. As well, the terms “a” (or “an”), “one or more” and “at least one” can be used interchangeably herein. It is also to be noted that the terms “comprising”, “including”, and “having” can be used interchangeably.

In a first aspect, the present invention relates to a method of depositing metals or metal oxides onto a substrate. In the method of the invention, a metal or metal oxide suspension is deposited on a substrate by electrospraying. Electrospraying involves generating an electric field between a metal or metal oxide suspension contained, for example, in a tip of a syringe and a substrate. When the applied electric field strength exceeds the surface tension required to release a droplet of the metal or metal oxide suspension from the syringe, a spraying effect, i.e. electrospraying or electrostatic spraying, occurs whereby metal or metal oxide-containing droplets are expelled in a fine mist of atomized particles from the syringe tip.

In an exemplary embodiment of the invention, the applied electric field has a field strength of about 0.25 kV/cm-0.75 kV/cm. In exemplary embodiments of the present invention, the applied electric field strengths may be in the range of from about 0.2 kV/cm to about 4 kV/cm and more preferably, from about 0.3 kV/cm to about 3 kV/cm. The tip-to-collector distance is below about 30 cm, preferably about 20 cm.

Metal and/or metal oxide particles are suspended in a suspension and the suspension is electrosprayed, in order to deposit the particles on the substrate. Electrospraying is a similar technique to electrospinning but the conditions are such that the suspension is made to spay in a fine mist, atomized particles, rather than as continuous fibers by varying the applied electric field to higher values than are used for electrospinning Electrospraying has been used as a coating technique in various industries such as the automobile industry. It is desirable, in the present invention, that the metal and/or oxide solid content in suspension is 0.5%-20% of the total suspension weight and, more preferably, the metal and/or metal oxide content 3%-10% of the total suspension weight. Below the lower limit of metal and/or metal oxide concentration in the suspension, the mixture does not expel to deposit onto the electrospun nanofiber. If the metal and/or oxide content in the suspension exceeds the upper limit, the syringe needle is easily clogged to prevent of the ejection of Metal oxide particles.

Metal and/or metal oxide particles 4 may include any metals or metal oxides capable of binding to a surface of fiber-substrate matrix 2, 3. In an exemplary embodiment, metal oxide particles 4 may have photocatalytic properties. Preferably the photocatalytic metal oxides may be TiO₂ (titania), ZnO, ZrO₂, WO. Other suitable metal oxides include metal oxides with antibacterial properties, such as CaO, MgO, FeO, Fe₂O₃, V₂O₅, Mn₂O₃, Al₂O₃, NiO, CuO, SiO₂. Suitable metals are metals with antibacterial properties such as Ag, Zn, Cu and any combination thereof.

The particles used to prepare the spraying suspension may have particle sizes of from about 2 nm to about 1 μm, more preferably, from about 5 nm to about 50 nm and, most preferably, from about 10 nm to about 30 nm. The particle size of the particles used to prepare the suspension influences the particle size of the metal or metal oxide particles deposited on the substrate. Generally, it is desirable to deposit metal and/or metal oxide particles on the substrate having particle sizes of from about 2 nm to about 1 μm, more preferably, from about 5 nm to about 50 nm and, most preferably, from about 10 nm to about 30 nm.

A variety of different materials such as solvents may be used to prepare the particle suspensions. Exemplary solvents include, but are not limited to, deionized water or other polar solvents. The solvent must be capable of suspending a sufficient amount of the metal and/or metal oxide to prepare a suitable sprayable suspension as discussed above. At least one chelating agent such as acetylacetone, ethylacetoacetate, oxalic acid, pentamethylene glycol, phosphonic acids, gluconic acid and diacetone alcohol may be included in the metal oxide suspension in order to enhance the dispersion of the particles in the suspension.

The precise morphologies and physical properties of particles 4 are determined by the selection of the metal and/or metal oxide, specifying the concentration of the metal and/or metal oxide suspension, selecting the conductivity of the solvents used in the suspension and the applied electric field strength. Each of these factors may be varied to produce metal and/or metal oxide particle coatings having different properties.

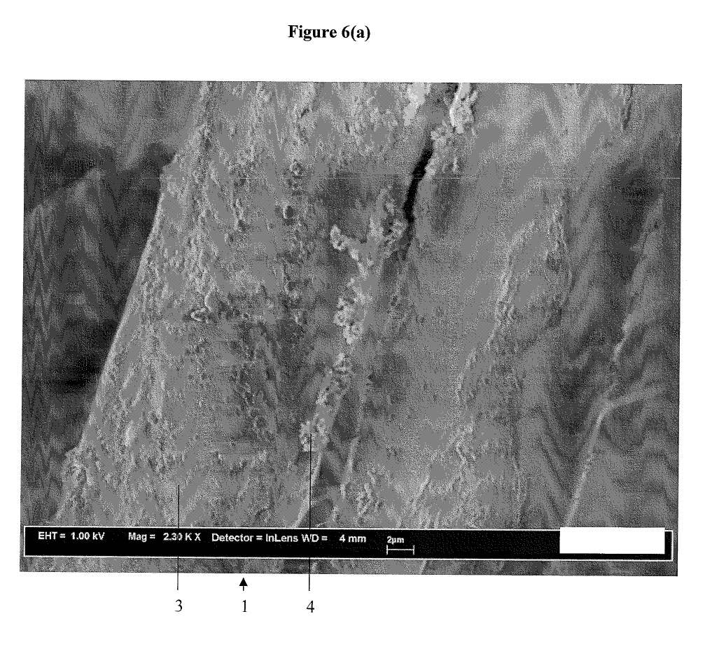

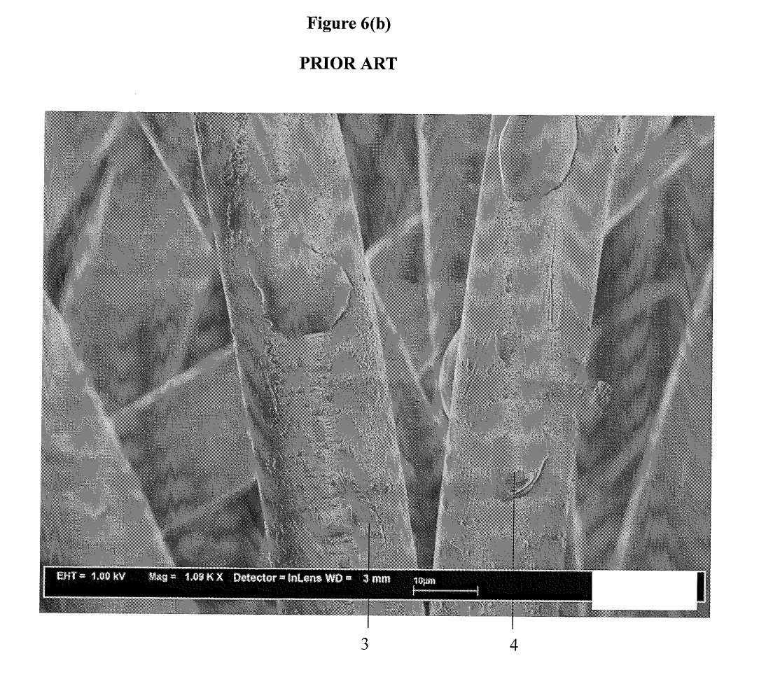

Preferably, particles 4 are substantially uniformly deposited on substrate matrix 3, 2 during the electrospraying process. In comparison to the dipping method of the prior art, shown in FIG. 6(b), in which undesirable agglomeration of metal oxide particles occurs, the electrospraying process of the present invention enables a more uniform particle size distribution and avoids substantial agglomeration of the metal oxide particles 4, as shown, for example, in FIG. 6(a).

In some embodiments, it is desirable to wash the substrate prior to electrospraying the particle suspension thereon in order to enhance the adhesion of the metal and/or metal oxide to the substrate. Washing can be carried out with any suitable solvent including, for example, deionized water and non-aqueous polar solvents like alcohols. Drying may be carried out under conditions that do not damage the substrate, such as drying at ambient temperature.

In some embodiments, it may also be desirable to carry out a surface modification step on the substrate prior to electrospraying and, optionally, after carrying out a washing step. Surface modification is also designed to enhance adhesion of the metal and/or metal oxide to the substrate. Conventional surface modification techniques may be employed, such as treating the substrate with a silica containing solution, and oven drying the treated substrate at a temperature of, for example, 50° C.-70° C. The surface modification step may employ a binder material that enhances the ability of particles 4 to adhere to substrate 2. Preferably, the binder material may be stable up to temperatures of at least about 200° C. More preferably, the binder may be hydrophilic or may have a hydrophilic functional group. In an exemplary embodiment, the binder material may include at least one silica precursor, such as tetraethyl orthosilicate (TEOS) or tetramethyl orthosilicate (TMOS), tetra-n-propoxysilane, tetra-n-butoxysilane, and tetrakis(2-mehoxyethoxy) silane, and organoalkoxysilanes such as methyltriethoxysilane, methyltrimethoxysilane, methyl tri-n-propoxysilane, phenylriethoxysilane, vinyltriethoxysilane. The binder material is preferably acidic and thus, may contain, for example, an inorganic acid such as hydrochloric acid, nitric acid, sulfuric acid, phosphoric acid, and suitable organic acids such as acetic acid, dichloroacetic acid, trifluoroacetic acid, benzenesulfonic acid, toluenesulfonic acid, xylenesulfonic acid, ethylbenzenesulfonic acid, benzoic acid, phthalic acid, maleic acid, formic acid and oxalic acid. Also, preferably the pH is in the range of 1-6, and more preferably 2-5.

Substrate 2 may be modified with binder agent 5 by any conventional coating means, including dip coating or spray coating. Dip coating is preferred because it can coat the whole filter fiber. The resultant coated substrate 2 may then be ultrasonicated and dried.

The resultant deposited material of the present invention is advantageous because it may be highly flexible, thereby enabling the material to be incorporated in movable and bendable structures as well as flexible membranes, such as textiles and fabrics. Additionally, the deposited material may be fabricated to produce any desired pore size, including nanometer or micrometer sized pores suitable for fine filtration applications. The metal oxides of the present invention may also be selected to have photocatalytic properties to enable antimicrobial applications.

In view of these advantages, the deposited materials of the present invention may be used for a wide variety of applications. It is envisioned that products made by the method of the invention may be used for biomedical applications, such as artificial tissues and scaffolds, electronic applications, such as electronic packaging, sensors, actuators and fuel cells, and filtration systems, such as filtration media and biological and chemical protection systems.

Substrate 2 may be fabricated using any suitable means. The electrospraying process of the present invention may be advantageously incorporated as part of a fabrication method which employs electrospinning of a polymeric material to provide at least a portion of the substrate.

In an exemplary embodiment, the substrate material 1 may be a flexible and porous fibrous matrix on which metal and/or metal oxide particles have been deposited. Material 1 may be fabricated to have any desired pore size, including micron and nanometer sized pores and may also possess photocatalytic properties. In an exemplary embodiment, the invention is directed to an electrospun nanofibrous material electrosprayed with a photocatalytic metal oxide.

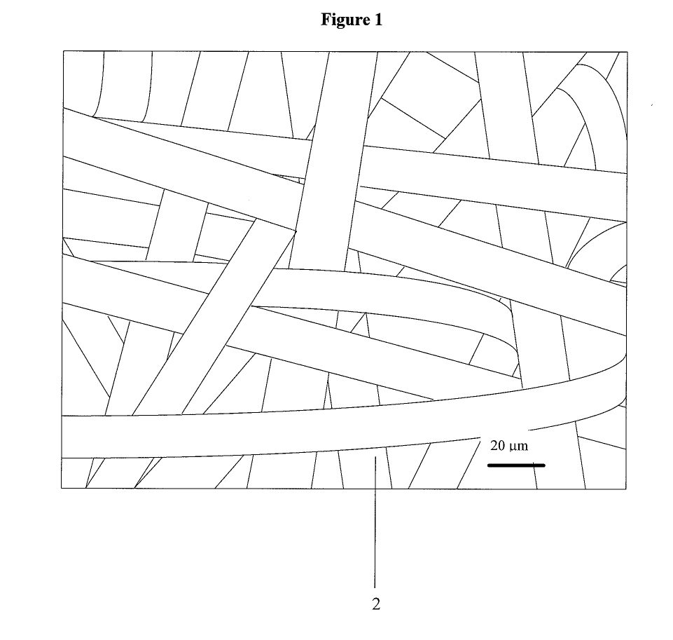

The deposited fibrous material 1 may be a composite matrix comprising a substrate 2, fibers 3 and metal and/or metal oxide particles 4. As shown in FIG. 1, substrate 2 may be any conventional porous scaffold or mesh structure suitable for supporting and/or binding fibers 3 thereto. In an exemplary embodiment, substrate 2 may be synthesized from at least one polymeric material, including but not limited to, polypropylene, polyethylene, polycarbonate, polyurethane and, polyester, polybutene, polyisobutene, polypentene, polybutadiene, polyvinyls such as polyvinyl chloride or polyvinyl alcohol, poly(meth)acrylic acid, polymethylmethacrylate (PMMA), polyacrylocyano acrylate, polyacrylonitrile, polyamide, polyester, polystyrene, polytetrafluoroethylene, as well as mixtures thereof.

A variety of suitable support matrices are described in U.S. patent application publication no. US 20080110342, the disclosure of which is hereby incorporated by reference for the purpose of describing suitable support matrices for use in the present invention.

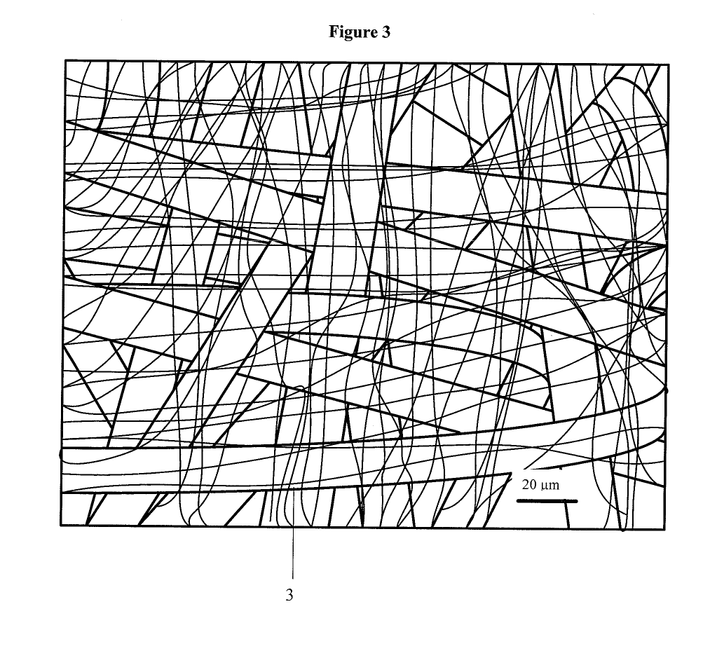

Deposited fibrous material 1 further includes fibers 3, preferably formulated as nanofibers. As shown in FIG. 3, fibers 3 may form a web that is supported by and bound to substrate 2. Fibers 3 may be synthesized from any suitable polymer capable of adhering to or being supported by substrate 2. In an exemplary embodiment, the polymer may include polyamides, such as polyamide 11 and polyamide 12, poly(vinyl acetate), poly(vinylidene fluoride), poly(vinyl pyrrolidone), poly(ethylene oxide), poly(acrylonitrile), poly(caprolactone), poly(methyl methacrylate), polycarbonate, polystyrene, polysulfone, acrylonitrile/butadiene copolymer, cellulose, cellulose acetate, chitosan, collagen, DNA, fibrinogen, fibronectin, nylon, poly(acrylic acid), poly(chloro styrene), poly(dimethyl siloxane), poly(ether imide), poly(ether sulfone), poly(ethyl acrylate), poly(ethyl vinyl acetate), poly(ethyl-co-vinyl acetate), poly(ethylene terephthalate), poly(lactic acid-co-glycolic acid), poly(methyl methacrylate), poly(methacrylic acid) salt, poly(methyl styrene), poly(styrene sulfonic acid) salt, poly(styrene sulfonyl fluoride), poly(styrene-co-acrylonitrile), poly(styrene-co-butadiene), poly(styrene-co-divinyl benzene), poly(vinyl alcohol), poly(vinyl chloride), polyacrylamide, polyaniline, polybenzimidazole, poly(dimethylsiloxane-co-polyethyleneoxide), poly(etheretherketone), polyethylene, polyethyleneimine, polyimide, polyisoprene, polylactide, polypropylene, polyurethane, poly(vinylidene fluoride), poly(vinylpyrrolidone), poly(2-hydroxyethyl methacrylate) (PHEMA), proteins, SEBS copolymer, silk (natural or synthetically derived), styrene/isoprene copolymer and combinations or polymer blends thereof. Polymer blends may be employed as long as the two or more polymers are soluble in a common solvent or mixed solvent system. Examples of possible polymer blends include poly(vinylidene fluoride)-blend-poly(methyl methacrylate), polystyrene-blend-poly(vinylmethylether), poly(methyl methacrylate)-blend-poly(ethyleneoxide), poly(hydroxypropyl methacrylate)-blend poly(vinylpyrrolidone), poly(hydroxybutyrate)-blend-poly(ethylene oxide), protein blend-polyethyleneoxide, polylactide-blend-polyvinylpyrrolidone, polystyrene-blend-polyester, polyester-blend-poly(hydroxyethyl methacrylate), poly(ethylene oxide)-blend poly(methyl methacrylate), poly(hydroxystyrene)-blend-poly(ethylene oxide)) and combinations thereof.

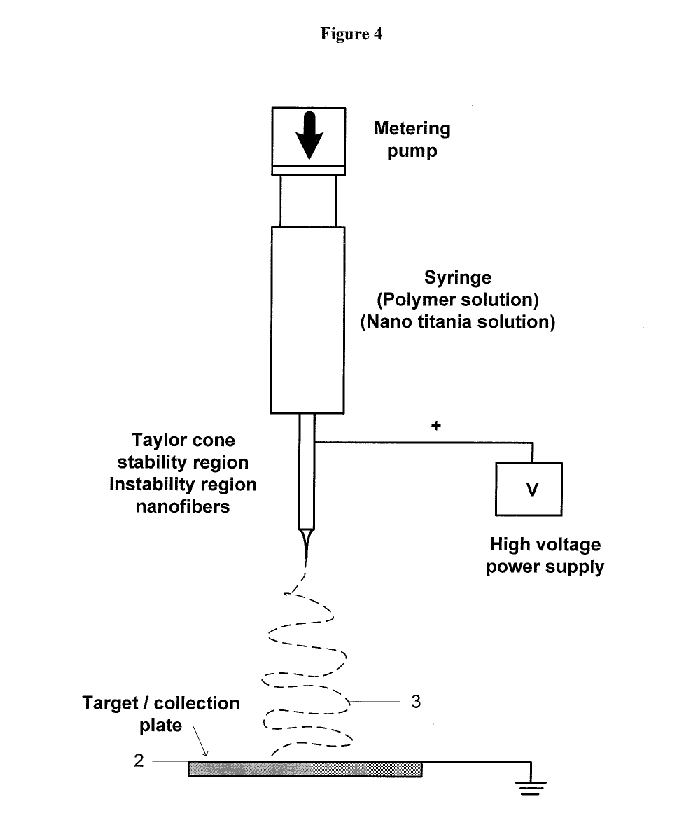

In an exemplary embodiment, fibers 3 may be fabricated by electrospinning a polymer solution onto the surface of substrate 2 to form a web of fibers 3. As shown in FIG. 4, this process involves generating an electric field between a polymer solution contained in a tip of a syringe and substrate 2. When the applied electric field strength exceeds the surface tension of a droplet of the polymer solution to be released from the syringe, the solution is ejected in a random spinning motion, i.e. jet or Taylor cone illustrated in FIG. 4. The electric field applied in an exemplary embodiment of the invention has a field strength in the range of about 0.2 kV/cm to about 4 kV/cm and more preferably, of about 0.3 kV/cm to about 3 kV/cm. As the polymer solution is projected towards substrate 2, the solvent in the polymer solution evaporates before collecting on the substrate, thereby producing long continuous polymer fibers are deposited on substrate 2.

The polymer solution may include any polymer or polymer mixtures, preferably the above listed polymers, and corresponding solvents to dissolve said polymers. Alternatively or in addition thereto, the solution may include polymers which have been melted. Optionally, the solution may also include any additives or filler suitable for forming fibers by electrospinning. In an exemplary embodiment, the additives or fillers may be added to change the resultant fiber size and quality. For example, the addition of trace amounts of salts and/or surfactants may increases solution conductivity and the charge accumulation at the tip of the electrospinning device, generating greater stretching forces and smaller diameter fibers. Surfactants may also reduce the surface tension of the polymer allowing for smaller fibers. In an exemplary embodiment, the surfactants may include, but are not limited to, tetrabutyl ammonium chloride (TBAC), cesium dodecyl sulfate (CsDS), sodium dodecyl sulfate (SDS), tetramethyl ammonium dodecyl sulfate (TMADS), tetraethyl ammonium dodecyl sulfate (TEADS), tetrapropyl ammonium dodecyl sulfate (TPADS), tetrabutyl ammonium dodecyl sulfate (TBADS) and octylphenol poly(ethylene glycol ether) and the salts may include, but are not limited to, lithium chloride and lithium triflate, sodium nitrate, calcium chloride, sodium chloride, formates, acetates, propionates, malates, maleates, oxalates, tartrates, citrates, benzoates, salicylates, phthalates, stearates, phenolates, sulfonates, and amines, as well as mixtures thereof.

In one embodiment of the present invention, polymer concentration in the electrospinning solution may influence the properties of the electrospun fibers. Concentrations from 2 wt % to 30 wt %, based on the total weight of the polymer solution, may be suitable for the present invention with a more preferred range of about 4 wt % to about 20 wt %.

A variety of suitable methods for electrospinning polymer fibers are described in, for example, U.S. patent application publication no. US 20080110342, the disclosure of which is hereby incorporated by reference for the purpose of describing suitable electrospinning methods for electrospinning polymers.

Electrospinning may be used to synthesize fibers with diameters ranging from several nanometers to several micrometers, depending upon the electrospinning conditions and selected polymer solution. In an exemplary embodiment, the fibers are nanosized fibers of about 100 nm to about 2 μm, more preferably 500 nm to about 1 μm. The precise morphologies and physical properties of fiber 3 are determined by polymer selection, specifying the concentration of the polymer solution, selecting the conductivity of the solvents used in the polymer solution and selection of an applying an electric field strength, needle diameter of syringe and injection speed of polymer solution. Each of these factors may be varied to fabricate polymeric fibers having different properties.

In another embodiment, the present invention relates to metal and/or metal oxide deposited materials. In an exemplary embodiment, particles 4 may be substantially uniformly distributed on a surface of matrix 3, 2 and/or have a relatively narrow particle size distribution indicating that the particles 4 do not substantially agglomerate into large particles. Usually, in the case of dip coating, the particle size of deposited metal oxide particles such as TiO₂ on the filter substrates is at least 100 nm due to agglomeration. On the other hand, metal oxides such as TiO₂ deposited by electrospraying usually have particle sizes of below 100 nm and, more preferably, below 50 nm. Also, electrospraying results in more uniformly deposited metal oxide such as TiO₂ on the substrate.

In one embodiment, the present invention relates to filtration materials made by a process of the present invention wherein the fibrous portion of the substrate is fabricated by electrospinning and the metal and/or metal oxide is applied by electrospraying. In such filtration devices, electrospraying allows the particles 4 to be distributed such that they do not substantially block or prevent the flow of air through the pores of fiber-substrate matrix 3, 2. Preferably, particles 4 are nanosized powder particles which provide a layer of fine coating over fiber-substrate matrix 3, 2. Therefore, the resultant matrix has a smaller pore size and larger specific surface area as compared to a fiber-substrate matrix prepared by dip coating metal oxide particles onto the substrate, as well as compared to many conventional filtration systems.

Of these various applications, the invention may be particularly beneficial for filtration systems, specifically antimicrobial filtration systems. The material of the present invention may be synthesized as a nanofibrous matrix, which when coated with nanosized metal and/or metal oxide particles, is capable of fine filtration. The material may then be formulated as, applied to or incorporated in a textile or fabric to contain or filter out undesirable particles and pollutants.

In an exemplary embodiment, the product of the invention may be a photocatalytic metal oxide deposited nanofibrous material having a large specific surface area for antimicrobial activity. The photocatalytic metal oxide particles may function to contain, inhibit or render ineffective bacteria, viruses and other microorganisms. When the photocatalytic metal oxide is illuminated by visible or ultra violet light having a higher energy than its band gaps, the valence electrons in the photocatalytic metal oxide will excite to the conduction band, and the electron and hole pairs will form on the surface and bulk inside of the metal oxide photocatalyst. These electron and hole pairs generate oxygen radicals, O²⁻, and hydroxyl radicals, OH⁻, after combining oxygen and water, respectively. Because these chemical species are unstable, when the organic compounds contact the surface of the photocatalyst, it will combine with O²⁻ and OH⁻, respectively, and turn into carbon dioxide (CO₂) and water (H₂O). Through the reaction, the photocatalytic metal oxide is able to decompose organic materials, such as odorous molecules, bacteria, viruses and other toxic or harmful microorganisms, in the air.

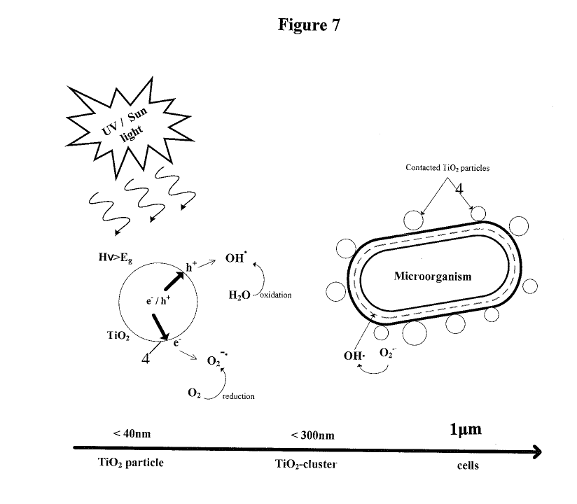

As shown in FIG. 7, the antimicrobial activity of the photocatalyst involves oxidative damage of the cell wall where the photocatalytic metal oxide contacts the microorganism. Upon penetration of the cell wall, the photocatalytic metal oxides may gain access to and enable photooxidation of intracellular components, thereby accelerating cell death.

### Example

Titania deposited nanofibrous material of the present invention was synthesized according to the following method. A polypropylene filter substrate was washed and cleaned by dipping into a deionized water and polar solvent mixture. It was subsequently dried at ambient temperature before being dip coated in a silica binder solution. The substrate was then ultrasonicated and dried in an oven at about 50° C. to about 70° C.

A solution of 2 grams of polyamide 11 in 48 g of formic acid/dichloromethane of 30 ml equal volume amount was prepared. This solution was heated on a heating plate while stirring. This polyamide solution was then electrospun onto the silica coated substrate at an applied electric field strength of about 1 kV to about 30 kV, to produce polyamide nanofibers.

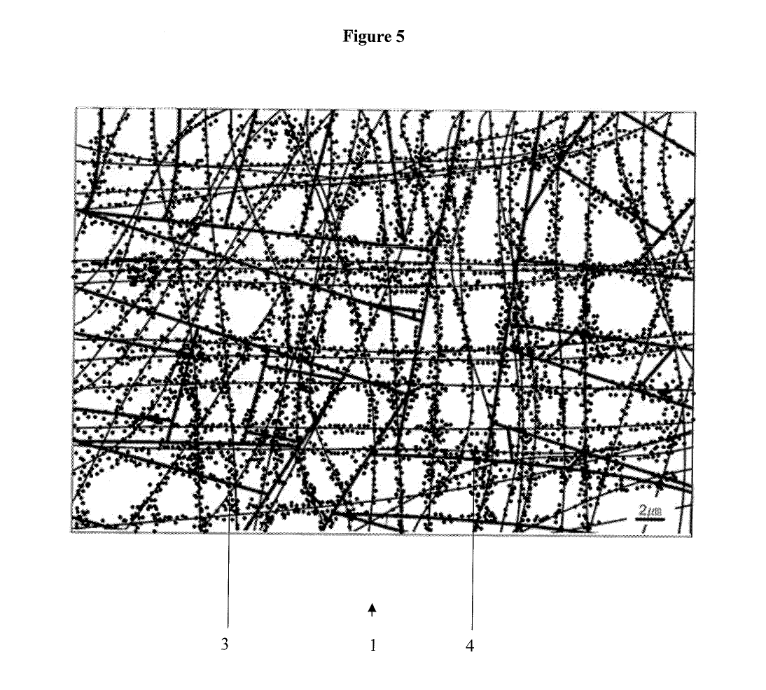

Nanosized titania particles of about 10 nm to about 15 nm in diameter were then suspended in a suspension with deionized water and ethanol 50:50 (w/w) and electrosprayed onto the polyamide nanofibers. The titania particles were electrosprayed using an applied electric field strength of about 5 kV to about 15 kV. The morphology of the electrospun fiber surface is shown schematically in FIG. 5 and in the scanning electron micrograph of FIG. 6(a).

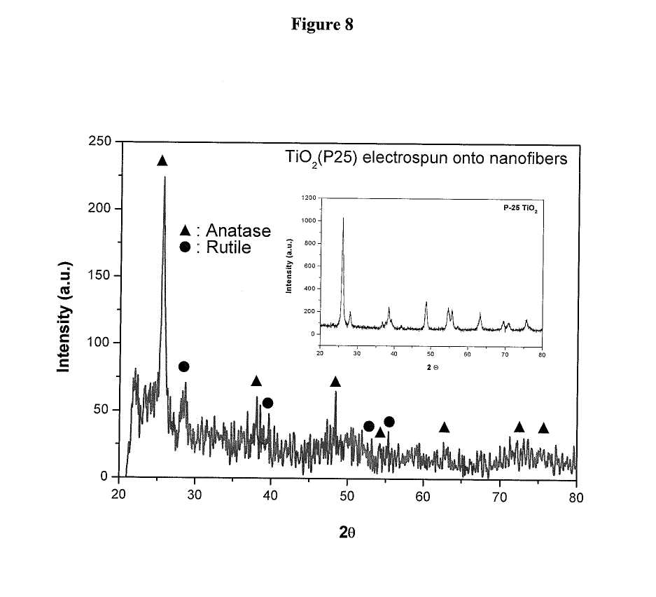

The titania coated electrospun nanofiber filter is analyzed by the X-ray diffraction analysis (XRD) with nickel filtered Cu Kα radiation (FIG. 8). The diffraction peak of anatase (101) phase is selected to measure the crystallinity of the samples and it is calculated by following the well known Scherrer equation;

$$d = \frac{0.89 λ}{βcos θ}$$

Where, λ=1.5418 Å (Cu Kα) and β is the full width at half maximum (FWHM) at the diffraction angle of θ.

### Comparative Example

Titania particles were applied to the same substrate as was used in the Example above using a dip coating process similar to that described in Kenawy, E. R. and Y. R. Abdel-Fattah (2002) “Antimicrobial properties of modified and electrospun poly(vinyl phenol).” Macromolecular Biosciences 2(6): 261-266. It was found that significant agglomeration of the titania occurred as a result of this process leading to a non-uniform distribution of titania on the substrate, as well as the formation of larger agglomerated titania particles. The formation of the larger agglomerated particles is disadvantageous since it decreases the effective surface area of the titania available to provide anti-microbial activity relative to smaller particles of the same amount of titania. The product made in this comparative example is shown in FIG. 6(b).

The foregoing examples have been presented for the purpose of illustration and description and are not to be construed as limiting the scope of the invention in any way. The scope of the invention is to be determined from the claims appended hereto.

What is claimed is:

1. A method for depositing metal or metal oxide particles onto a substrate comprising the steps of:
providing a metal or metal oxide suspension,
electrospraying the suspension onto the substrate; and
drying the sprayed substrate to deposit metal or metal oxide particles onto the substrate.

2. The method of claim 1, further comprising the step of coating said substrate with a binder material prior to said electrospraying step.

3. The method of claim 1, wherein said metal or metal oxide particles have a particle diameter not greater than 100 nm.

4. The method of claim 1, wherein said electrospraying is carried out at a field strength of about 0.2 kV/cm to about 4 kV/cm.

5. The method of claim 4, wherein said metal or metal oxide makes up 0.5 wt %-20 wt % of the total suspension weight.

6. The method of claim 1, wherein the metal oxide is a photocatalytic material.

7. The method of claim 1, wherein the metal or metal oxide is selected from the group consisting of TiO₂, ZnO, ZrO₂, CaO, MgO, FeO, Fe₂O₃, V₂O₅, Mn₂O₃, Al₂O₃, NiO, CuO, SiO₂, Ag, Zn, Cu and combinations thereof.

8. The method of claim 1, wherein the metal oxide is TiO₂.

9. The method of claim 1, wherein the metal oxide suspension further comprises a sufficient amount of at least one chelating agent to enhance the dispersion of metal oxide particles in the suspension.

10. A process of producing nanometer diameter metal oxide particles deposited on electrospun nanofibers on a matrix comprising the steps of:
electrospinning of a polymer solution onto a matrix;
electrospraying a metal oxide suspension onto said electrospun nanofibers; and
drying the electrosprayed metal oxide suspension.

11. The process of claim 10 further comprising the step of modifying the matrix by treatment with a silica-containing binder solution.

12. The process of claim 11, further comprising the step of washing the matrix with a solvent selected from deionized water and non-aqueous polar solvents prior to said modification step in order to enhance the wetting of conventional filter fiber materials.

13. The process of claim 11 wherein, said matrix comprises woven or nonwoven conventional fabrics and said modification step comprises coating said matrix with a binder solution containing at least one silica-containing binder selected from the group consisting of as tetraethyl orthosilicate, tetramethyl orthosilicate, tetra-n-propoxysilane, tetra-n-butoxysilane, and tetrakis(2-mehoxyethoxy) silane, and organoalkoxysilanes such as methyltriethoxysilane, methyltrimethoxysilane, methyl tri-n-propoxysilane, phenylriethoxysilane, vinyltriethoxysilane and mixtures thereof.

14. The process of claim 13, wherein the binder solution further comprises an inorganic acid.

15. The process of claim 10 wherein, said metal oxide suspension further comprises a sufficient amount of at least one chelating agent to enhance the dispersion of metal oxide particles in the suspension.

16. The process of claim 10 wherein the polymer used for electrospinning is selected from the group consisting of polyamide 11, polyamide 12, poly(vinyl acetate), poly (vinylidene fluoride), poly(vinylpyrrolidone), poly(ethylene oxide), poly(acrylonitrile), poly(caprolactone), or poly(methyl methacrylate).

17. A metal or metal oxide deposited fibrous material made by the process of claim 10, comprising:
a matrix having pores;
fibers supported by or bound to said matrix; and
metal or metal oxide particles dispersed on a surface of said matrix, wherein substantially all of said metal or metal oxide particles have a diameter of less than 100 nm and said metal or metal oxide particles do not substantially block said pores.

18. The metal or metal oxide deposited fibrous material of claim 17, wherein said fibers are fabricated from a polymer selected from the group consisting of: polyamides, poly(vinyl acetate), poly(vinylidene fluoride), poly(vinylpyrrolidone), poly(ethylene oxide), poly(acrylonitrile), poly(caprolactone), poly(methyl methacrylate) and combinations thereof.

19. The metal or metal oxide deposited fibrous material of claim 17, wherein said substrate, said fibers or a combination thereof are coated with a binding material.

20. The metal or metal oxide deposited fibrous material of claim 19, wherein said binding material is hydrophilic.
